(19) United States
(12) Patent Application Publication
(10) Pub. No.: US 2018/0135304 A1
(43) Pub. Date: May 17, 2018

(54) Passive Skylight Dome Configured to Increase Light Collection At Low Sun Elevation Angles and To Reduce Light at High Sun elevation Angles

(71) Applicant: David Gelbaum, Cosa Mesa, CA (US)

(72) Inventor: David Gelbaum, Cosa Mesa, CA (US)

(21) Appl. No.: 15/812,883

(22) Filed: Nov. 14, 2017

Related U.S. Application Data
(60) Provisional application No. 62/421,760, filed on Nov. 14, 2016.
(60) Provisional application No. 62/504,685, filed on May 11, 2017.

(51) Int. Cl. E04D 13/03; F21S 11/00

(52) U.S. Cl. CPC E04D 13/033; F21S 11/002

(57) ABSTRACT

The present subject matter comprises a simple, passive skylight dome with relatively tall partially vertical sides comprising partially transparent material which diffuses the transmitted light, and a mostly opaque sun shade near the top of the relatively tall partially vertical sides. The partially vertical sides are able to better intercept sunlight from low sun elevation angles than conventional horizontal skylights. The mostly opaque sun shade is able to block sunlight from high sun elevation angles to prevent such sunlight from entering the building below the dome. By enhancing the collection of low-sun-elevation-angle light, the subject matter improves the daylight performance of the skylight early and late in the day, and all day in the winter months. By reducing the collection of high-sun-elevation-angle light, the subject matter reduces the solar heat gain near solar noon in the summer months, thereby reducing air conditioning loads and related costs.

### CROSS REFERENCE

The present application is a utility of and claims priority benefit of U.S. Provisional Application No. 62/421,760, filed 14 Nov. 2016 entitled “Passive Skylight Dome Configured to Increase Light Collection at Low Sun Elevation Angles and To Reduce Light at High Sun Elevation Angles”, the entirety of which is hereby incorporated herein by reference. The present application is also a utility of and claims priority benefit of U.S. provisional Application No. 62/504,685, filed May 11, 2017 titled Skylight Dome Containing Diffusing Strips to Minimize Glare for Low Sun Elevation Angle Light, the entirety of which is also incorporated herein by reference.

### BACKGROUND

Conventional horizontal skylights suffer from poor sunlight collection when the sun is low in the sky, i.e., when the sun's elevation angle is small. This poor low-sun-elevation angle performance leads to poor lighting in the wintertime in most moderate latitudes, and to poor lighting early and late in the day in all locations. Previous attempts to solve this problem have sometimes used expensive tracking reflectors above the skylight penetration into the building, or sometimes used fixed reflectors or prismatic lenses above the skylight penetration with less than adequate performance.

Conventional horizontal skylights also suffer from excess sunlight collection when the sun is high in the sky, i.e., when the sun's elevation angle is large. This excess sunlight collection during summer months near solar noon increases solar heat gain with corresponding increases in air conditioning loads and costs. Previous attempts to solve this problem have sometimes used expensive blinds and baffles to block some of the excess sunlight collection with less than satisfactory performance, reliability, and cost.

The present subject matter uses a relatively tall diffusely transmitting dome to collect low sun elevation light, with an opaque shade near the top of the dome to block high sun elevation light, thereby solving both problems by both increasing inadequate sunlight collection during low sun elevation periods and also by decreasing excess sunlight collection during high sun elevation periods. The present subject matter solves both problems in a totally passive manner, requiring no moving parts and no seasonal change in configuration of the skylight. Therefore, the present subject matter represents a simple, reliable, cost-effective solution to two major problems for horizontal skylights.

This subject matter includes at least one skylight dome with relatively tall partially vertical sides comprising partially transparent material which diffuses the transmitted light, and at least one mostly opaque sun shade near the top of the relatively tall partially vertical sides. The partially vertical sides are able to better intercept sunlight from low sun elevation angles, in contrast to conventional horizontal skylights which are less well able to intercept such low-sun-elevation-angle light. The mostly opaque sun shade is able to block sunlight from high sun elevation angles to prevent such sunlight from entering the building below the dome. By enhancing the collection of low-sun-elevation-angle light, the subject matter improves the daylighting performance of the skylight early and late in the day year-around, and all day in the winter months of the year. By reducing the collection of high-sun-elevation-angle light, the subject matter reduces the solar heat gain near solar noon in the summer months, thereby reducing air conditioning loads and related costs for equipment and operating energy. The simple passive configuration of the subject matter, with no moving parts and no operational complexity, ensures high reliability and low maintenance.

These and many other advantages of the present subject matter will be readily apparent to one skilled in the art to which the invention pertains from a perusal of the claims, the appended drawings, and the following detailed description of preferred embodiments.

### BRIEF DESCRIPTION OF THE DRAWINGS

FIGS. 1A and 1B present a perspective view and top view respectively according to an embodiment of the new skylight subject matter, comprising a rectangular geometry for the dome and mirrored pyramid shade.

FIG. 2 presents a perspective view of another embodiment of the new skylight subject matter, comprising a circular geometry for the dome and shade.

FIG. 3 presents a perspective view of an embodiment of the new skylight subject matter, comprising a rectangular geometry for the dome and shade, with a second interior dome for the better thermal performance.

FIG. 4 presents a perspective view of an embodiment of the new skylight subject matter, comprising a rectangular geometry for the dome and shade, with a second exterior dome for better thermal performance.

FIGS. 5A-5D present examples of different wedge configurations according to embodiments the disclosed subject matter.

### DETAILED DESCRIPTION

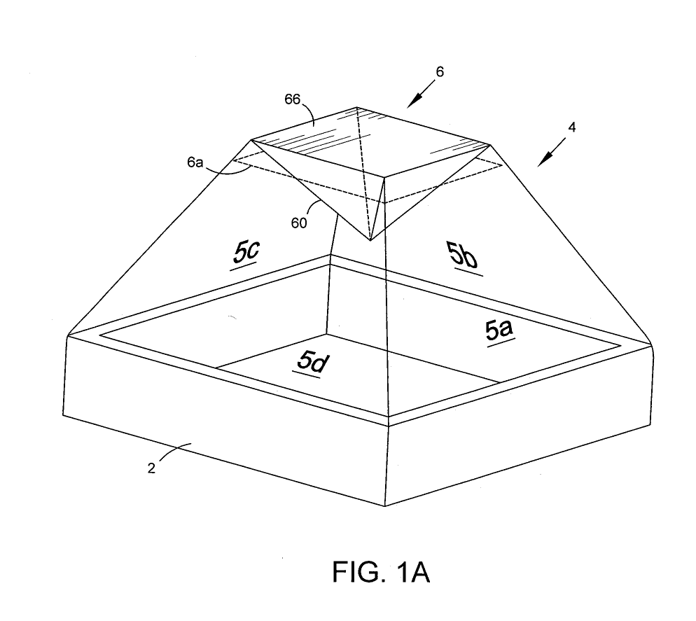

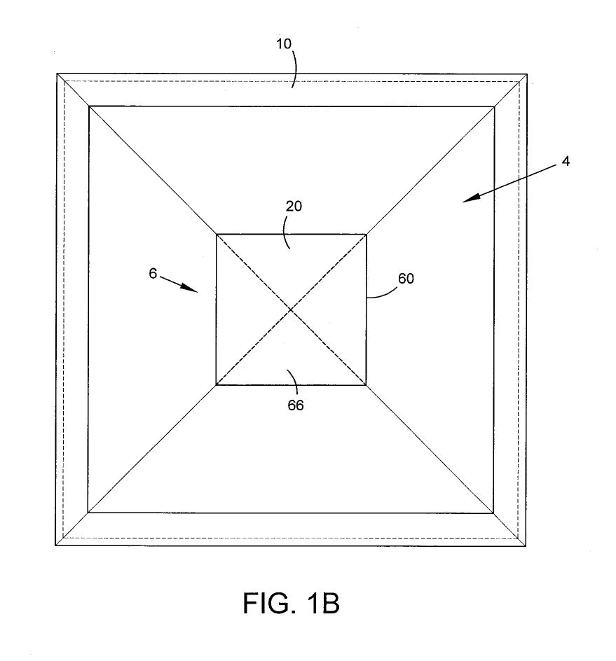

The present subject matter is best understood by referring to the attached drawings, which show several embodiments. Referring first to FIG. 1A, the subject matter is an improved skylight dome 4. As shown in FIG. 1A, this embodiment comprises a transparent dome 4 which can be a variety of shapes, but is shown for example only as a rectangular pyramidal shape in FIG. 1A. The transparent dome 4 can be made from acrylic plastic or polycarbonate plastic or tempered glass. The transparent dome 4 can include surface features such as prisms and/or bulk additives such as white pigment to provide diffusion of the sunlight transmitted into the dome, thereby minimizing glare from direct solar rays. The transparent dome 4 comprises a geometry with partially vertical sides (panes 5a-5d) able to collect sunlight from low sun elevation angles near the horizon. A mostly opaque/reflective sun shade 6 is located near the top of the transparent dome 4 to block high-sun-elevation-angle light from entering the building below the dome. The sun shade 6 can have a reflective inner surface, either diffusely reflecting like white paint or specularly reflecting like aluminized film to enhance the delivery to the building below of diffuse light which enters the dome 4. The dome 4 with sun shade 6 of FIG. 1A is generally installed on a curb structure 2 which provides support and weatherproofing for the skylight.

For the embodiment shown in FIG. 1A, the transparent dome 4 can be made from impact resistant acrylic plastic, to withstand hail and wind and sunlight exposure. The sun shade 6 can be made of the same material as the rest of the dome 4, but with a coating or film or sheet of mostly opaque material attached to the inner or outer surface of the shade 6 portion of the dome.

As would be apparent to one of ordinary skill in the art, the shape of the dome 4 and the sun shade 6 could comprise a variety of configurations while still providing the basic benefits of the present subject matter, with FIG. 1A showing just one embodiment. FIG. 1A also shows the sun shade 6 may optionally extend on to the partially vertical sides shown by line 6a. As shown in FIG. 1A an inverted pyramid. 60 may form part or all of the sunshade 6. The outer surfaces of the inverted pyramid 60 preferably are reflecting surfaces with reflective white paint or specularly reflecting aluminized film to enhance the delivery to the building below of diffuse light which enters the dome 4.

FIG. 1B is a top view of the embodiment of FIG. 1A. The area of the opening in the horizontal plane is generally represented as 10 and the area of the sun shade is generally represented as reference number 20. The sunshade 6 and the inverted pyramid shown as 60.

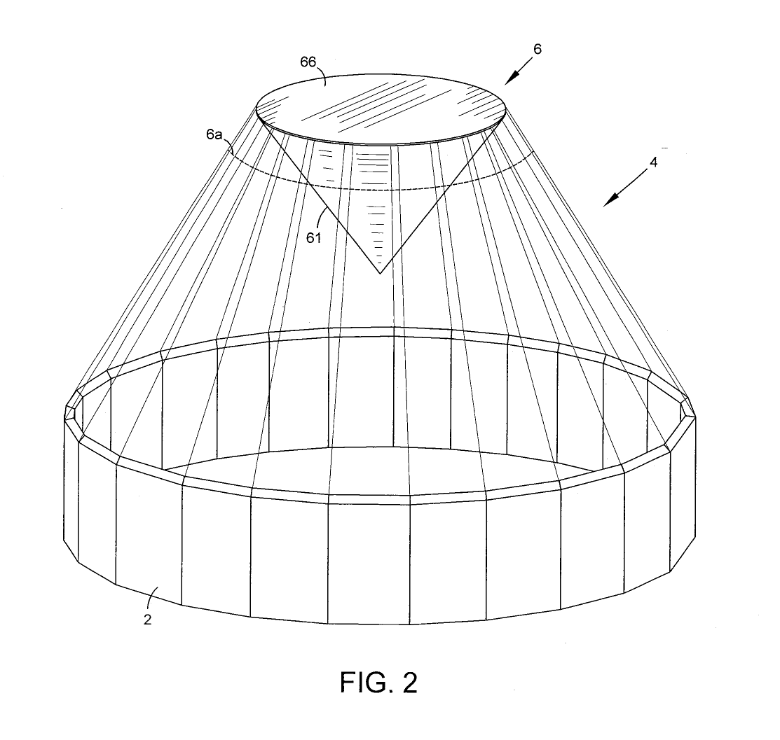

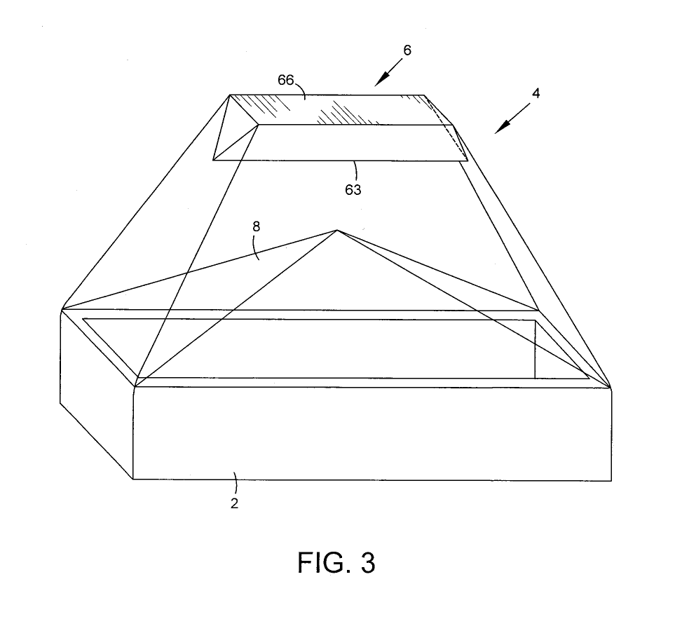

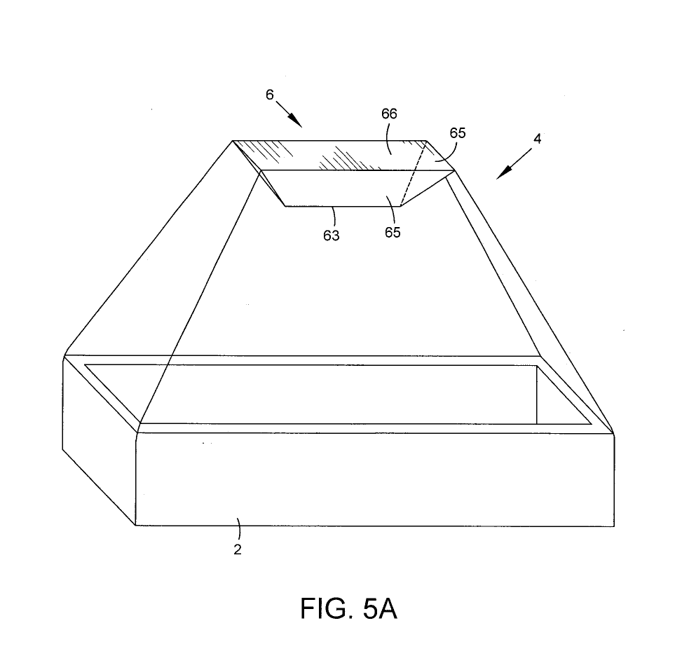

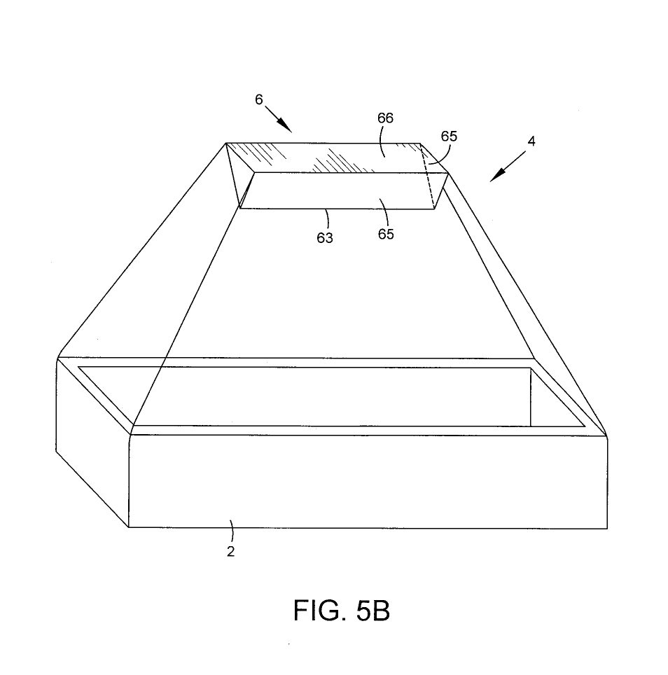

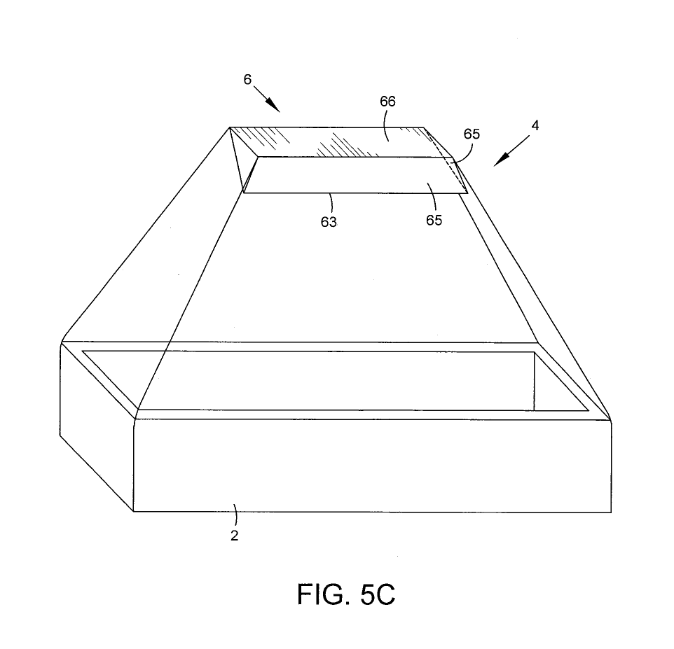

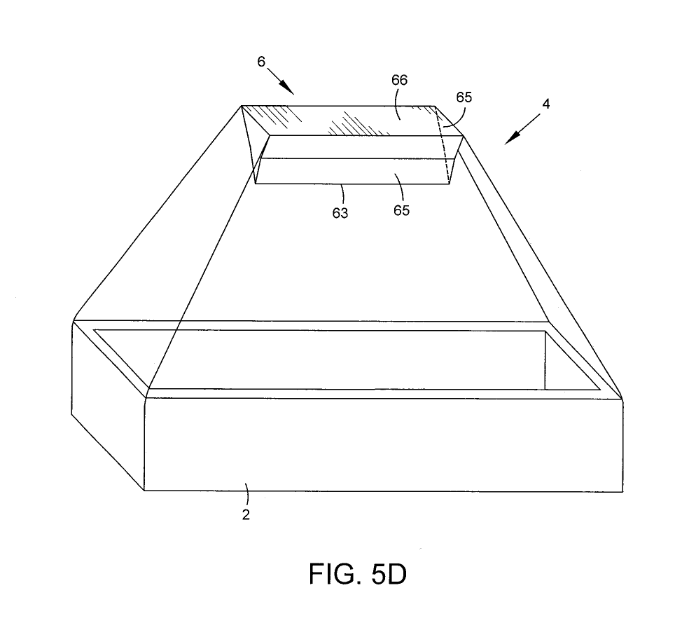

Referring next to FIG. 2, a second embodiment of the new subject matter is shown in a round geometry. The present subject matter will normally comprise a transparent dome 4 which can be a variety of shapes, but is shown for example only as a cylindrical cone shape in FIG. 2. The transparent dome 4 can be made from acrylic plastic or polycarbonate plastic or tempered glass. The transparent dome 4 can include surface features such a prisms and/or bulk additives such as white pigment to provide diffusion of the sunlight transmitted into the dome, thereby minimizing glare from direct solar rays. The transparent dome 4 comprises a geometry with partially vertical sides able to collect sunlight from low sun elevation angles near the horizon. A mostly opaque sun shade 6 is located near the top of the transparent dome 4 to block high-sun-elevation-angle light from entering the building below the dome. The circular sun shade 6 can have a reflective inner surface, either diffusely reflecting like white paint or specularly reflecting like aluminized film to enhance the delivery to the building below of diffuse light which enters the dome 4. Similar to what is shown in FIG. 1A, the sun shade may include an inverted cone 61. The outer surfaces (down and outward facing surfaces) of the inverted cone 61 preferably are reflecting surfaces with reflective white paint or specularly reflecting aluminized film to enhance the delivery to the building below of diffuse light which enters the dome 4. The underside of the sun shade 6 may also take the form of a tapered wedge 63 as shown in FIGS. 3 and 5A, a rectangular wedge as shown in FIG. 5B, a slanted wedge as shown in FIG. 5C, a concave wedge, or a rotated surface such as a cone, paraboloid, hyperboloid, etc. FIG. 5D shows a staged pyramid or staged wedge 63. While FIG. 2 shows an inverted cone as the sun shade 6, the cone shown in FIG. 2 may also be segmented. The dome 4 with sun shade 6 of FIG. 2 is generally installed on a curb structure 2 which provides support and weatherproofing for the skylight.

The outer surfaces 65 of the wedge, 63 preferably are reflecting surfaces with reflective white paint or specularly reflecting aluminized film to enhance the delivery to the building below of diffuse light which enters the dome 4. The upward facing surface 66 of the sunshade 6, may be

The transparent dome 4 can be made from impact resistant acrylic plastic, to withstand hail and wind and sunlight exposure. The sun shade 6 can be made of the same material as the rest of the dome 4, but with a coating or film or sheet of mostly opaque material attached to the inner or outer surface of the shade 6 portion of the dome. In FIG. 2, the inner surface (upward and inward facing surface) of the inverted cone 61 forms the inner surface of the sun shade 6. The inner surface of the sun shade 6 may be coated for example with a partially or mostly opaque film. The sunshade reflectors (the inverted pyramid 60, wedge 63 or cone 61) may be integrally formed and of the same material as the transparent dome 4. In which case the flat upward facing top surface of the sunshade 6 shown in the figures would be optional, instead as described above the inner surface of the sunshade 6 would provide the shading function.

As would be apparent to one of ordinary skill in the art, the shape of the dome 4 and the sun shade 6 could comprise a variety of configurations while still providing the basic benefits of the present subject matter, with FIG. 2 showing just one embodiment.

Referring next to FIG. 3, another embodiment of the subject matter is shown in a rectangular geometry. The embodiment shown includes a transparent dome 4 which can be a variety of shapes, but is shown for example only a truncated pyramidal shape in FIG. 3. The transparent dome 4 can be made from acrylic plastic or polycarbonate plastic or tempered glass. The transparent dome 4 can include surface features such a prisms and/or bulk additives such a white pigment to provide diffusion of the sunlight transmitted into the dome, thereby minimizing glare from direct solar rays. The transparent dome 4 comprises a geometry with partially vertical sides to collect sunlight from low sun elevation angels near the horizon. A mostly opaque sun shade 6 is located near the top of the transparent dome 4 to block high-sun-elevation-angle light from entering the building below the dome. The rectangular sun shade 6 can have a reflective inner surface, either diffusely reflecting like white paint or specularly reflecting like aluminized film, to enhance the delivery to the building below of diffuse light which enters the dome 4. The sunshade 6 may optionally include an inverted wedge 63 forming part or all of the sunshade 6. The outer surfaces of the inverted wedge 63 preferably are reflecting surfaces with reflective white paint or specularly reflecting aluminized film to enhance the delivery to the building below of diffuse light which enters the dome 4. In FIG. 3, the vertex line of the wedge 63 extends to opposite inner surface of the dome 4. The dome 4 with sun shade 6 of FIG. 3 is generally installed on a curb structure 2 which provides support and weatherproofing for the skylight.

For the embodiment shown in FIG. 3, the transparent dome 4 can be made from impact resistant acrylic plastic, to withstand hail and wind and sunlight exposure. The sun shade 6 can be made of the same material as the rest of the dome 4, but with a coating or film or sheet of mostly opaque material attached to the inner or outer surface of the shade 6 portion of the dome.

A difference between the third embodiment shown in FIG. 3 compared to the first embodiment shown in FIG. 1A is the addition of a second dome 8 to the skylight configuration. This secondary dome 8 can be placed beneath the dome 4 to reduce the heat loss from the building in the winter months, and to reduce the heat gain into the building in the summer months. This secondary dome 8 can be clear or diffuse in terms of transmitting sunlight. The secondary dome 8 may be made of the same material or may be of another material since it does not need to be protected from the environment. In addition, FIG. 3 differs from FIG. 1A in that the sun shade 6 is made of a upwardly tapered wedge 63 that tapers laterally inward as the top (base) of the wedge.

As would be apparent to one of ordinary skill in the art, the shape of the dome 4, the second dome 8, and the sun shade 6 could comprise a variety of configurations while still providing the basic benefits of the present subject matter, with FIG. 3 showing just one preferred embodiment.

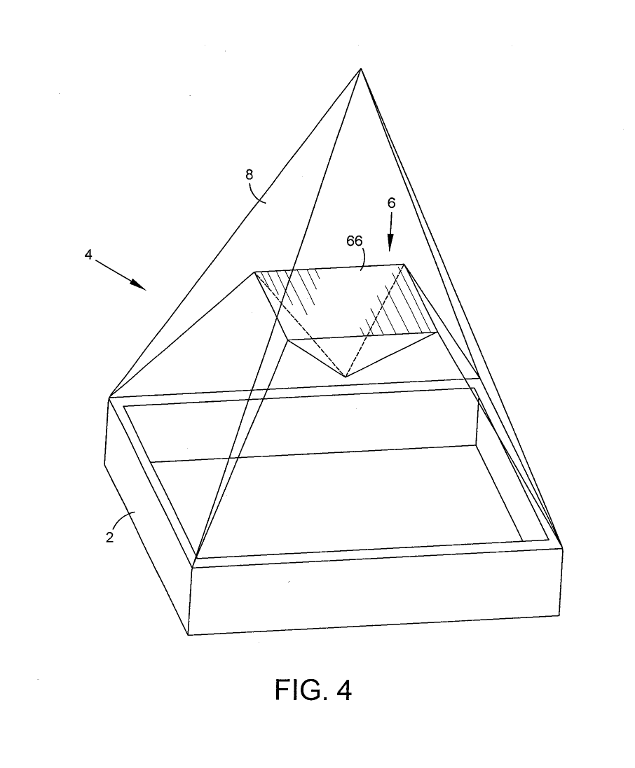

Referring next to FIG. 4, an embodiment of the new subject matter is shown in a rectangular geometry. The embodiment includes a transparent dome 4 which can be a variety of shapes, but is shown for example only as a truncated pyramidal shape in FIG. 4 similar to that shown in FIG. 1A, however, includes the addition of a second dome 8 to the skylight configuration. This secondary dome 8 unlike as shown in FIG. 3 may be placed above the dome 4 to reduce the heat loss from the building in the winter months, and to reduce the heat gain into the building in summer months. This outer second dome 8 can be clear or diffuse in terms of transmitting sunlight. Additionally, the volume between the first and second dome may be filled will a gas such as air, or may be filled with an insulating gas, such as argon, carbon dioxide, CF₄, or SF₆ to further improve the insulating properties of the skylight. This same introduction of insulating gas is also envisioned as being beneficial to the embodiment of FIG. 3.

As would be apparent to one of ordinary skill in the art, the shape of the dome 4, the second dome 8 and the sun shade 6 could comprise a variety of configurations while still providing the basic benefits of the present subject matter, with FIG. 4 showing just one embodiment.

The new skylight subject matter, of the embodiments shown in FIGS. 1A through 5D, and many other embodiments which can be conceived by those of ordinary skill in the art, offers many advantages over conventional skylights of the current state of the art. Unlike far more expensive skylight units which use motors and mechanisms to orient mirrors under the dome to help collect low sun elevation angle light, the new subject matter uses simpler, cheaper, passive means to accomplish the same objective. Unlike other less effective skylight units which use curved mirrors or prismatic lenses, the new subject matter uses simple, partially vertical, light-transmitting and light-diffusing surfaces to accomplish the same objective. Unlike conventional horizontal skylights, the new subject matter is able to collect far more low-sun-elevation-angle sunlight, providing much higher illumination early and late in the day, and in the wintertime when the sun is low in the sky all day for non-tropical latitudes. The new skylight subject matter thereby saves more energy for conventional electrical lighting, and therefore provides better economics, i.e., better return on investment and faster payback time.

An aspect of the current subject matter as discussed above is the relationship of area of the shaded portion to that of the unshaded portion. The subject matter seeks to maximize the collection of low sun elevation light and minimize the entry of high sun elevation light. The area of the sun shade 20 is less than the area of the opening 20 and preferably greater or equal to the non-shaded area as measured from a projection on a horizontal plane, (greater or equal to half the area of the opening 10). Likewise, in maximizing the low sun elevation light, it is preferable that the height of the transparent dome is equal or greater than one of the width or length of the base, or both. These parameters have a direct effect of minimizing unwanted light and maximizing desired light.

Another aspect of the current subject matter is the use of a one way reflective material on the inter portion of the transparent dome. The reflective inner coating allows light to pass from the outside into the transparent dome, but reflects at least some of the light incident upon it from the interior side. For example, with respect to FIG. 1A, a portion of the light passing through pane 5a from the low sun is reflected downward off the reflective interior surface of pane 5c, similarly light passing through pane 5c, is reflected downward off the interior surface of pane 5a. This one way reflection may be accomplished with thin film filters, coating or polarization. In addition, the sun shade 6 may also have one way reflective material but in the opposite manner than described above, such that light from the high sun elevation is reflected back, but light accident from the interior of the transparent dome is allow to pass. The important aspect of the sun shade is that it reflects/blocks high sun elevation light with the reflection characteristics of interior incident light being secondary to that primary function. With respect to the reflective properties of the transparent dome described above, the reflective material may be incorporated within, on the outside or inside of the panes of the dome. The above reflective properties may be incorporated not only on the dome 4, but also in the secondary dome 8.

The new skylight subject matter of the disclosed embodiments and of many other embodiments which will be generated by those skilled in the art of skylights based upon this subject matter, also blocks excessive sunlight when the sun is nearly overhead in the summer months. Blocking this excessive light and heat from entering the building will reduce air conditioning loads in the summer, thereby reducing the costs for cooling equipment and the energy to run such equipment. A more comfortable level of illumination will result from this shading of high-sun-elevation-angle light. The building occupants will be more comfortable from the reduced heat and light provided by this simple shade during the hours around solar noon in the hot summer months.

The opening or curb is envisioned as being of several shapes, such as rectangular, square, or polygonal as shown in the Figs. The shape may also be from a cross section of a rotated solid, such as circular or elliptical. In addition, while shown in the Figs as being a flat separate surface from the wall, the sun shade may also extend onto the walls as shown with reference to 6a and its projection onto the horizontal plane may be of any practical geometric shape to include rectangular, circular, elliptical, star, cross etc.

In describing the subject matter, the use of mostly opaque and mostly transparent are used. The use of mostly is intended to convey that for a mostly opaque surface less that 50 percent of the incident light is passed, whereas for mostly transparent surfaces, less than 50 percent of the incident light is blocked. In general, the opaque surfaces described herein would block (reflect or absorb) more incident light than the transparent surfaces described herein. A partially opaque surface is also envisioned for use in the disclosed subject matter in which between 20 and 50 percent of the incident light is not passed. A partially opaque surface may be achieved by increasing the thickness of a typically transparent material.

An aspect of the disclosed subject matter is the reflective surfaces of the sunshade project down into the volume bound by the walls or sides of the transparent dome. The degree to which they extend into the transparent dome is a function of the height of the side walls, the top area of the sun shade and the shape of the reflective surfaces. For example, FIG. 3 shows a relatively short wedge 63 which extends down about a fifth of the way into the dome 4, whereas FIG. 2 shows and inverted cone 61 which extends almost half way into the dome.

While preferred embodiments of the present invention have been described, it is to be understood that the embodiments described are illustrative only and that the scope of the invention is to be defined solely by the appended claims when accorded a full range of equivalence. Many variations and modifications naturally occurring to those of skill in the art from a perusal hereof are likewise encompassed.

What I claim is:

1. A skylight for providing natural lighting to the interior of a building comprising:
a transparent dome projecting above a roof of the building and defining at one end a light passage from the interior to the exterior of the building:
a sunshade located at another end of the transparent dome;
the sunshade comprising an upward facing surface that is at least partially opaque to light incident upon it and downward facing surfaces that are reflective of light incident upon them;
the downward facing surfaces of the sunshade being within the transparent dome and wherein at least one of the downward facing surfaces intersects with another of the downward facing surfaces within the transparent dome.

2. The skylight of claim 1, wherein the downward facing surfaces define a wedge.

3. The skylight of claim 1, wherein the downward facing surfaces define an inverted pyramid.

4. The skylight of claim 1, wherein the downward facing surfaces define an inverted cone.

5. The skylight of claim 1, wherein the downward facing surfaces define an inverted hyperboloid.

6. The skylight of claim 1, wherein the sunshade forms a top portion of the transparent dome.

7. The skylight of claim 1, wherein the downward facing reflective surfaces reflect light having an incident angle with respect to the horizon lower than a predetermined threshold.

8. The skylight of claim 7, wherein the threshold is selected as a function of the angle of the winter sun, summer sun, evening sun, morning sun or midday sun.

9. The skylight of claim 1, further comprising upward facing surfaces on the opposite side of the downward facing surfaces that prevent light with an incident angle greater than a threshold from entering the light passage.

10. The skylight of claim 9, wherein the upward facing surfaces are reflective.

11. A device for passively providing light from a source external to a building to an interior of a building comprising:
a transparent dome projecting light into the exterior of the building and defining at one end a light passage from the interior to the exterior of the building;
the transparent dome having a plurality of partially vertical sides extending from the one end to an upper end, the outer surfaces of the partially vertical sides facing at least partially upwards;
a sun shade at the upper end comprising:
a plurality of at least partially opaque surfaces;
a plurality of fixed reflective surfaces, each of said plurality of fixed reflective surfaces defined by a vector normal to their reflective surface having an angle with respect to the horizon;
each of the plurality of fixed reflective surfaces extending from the upper end towards the light passage and
wherein the reflective surfaces are positioned within said transparent dome,

12. The device of claim 11, wherein the reflective surfaces define a wedge.

13. The device of claim 11, wherein the reflective surfaces define an inverted pyramid.

14. The device of claim 11, wherein the reflective surfaces define an inverted cone.

15. The device of claim 11, wherein the reflective surfaces define an inverted hyperboloid.

16. The device of claim 11, wherein the sunshade forms a top portion of the transparent dome.
